(19) United States
(12) Patent Application Publication
(10) Pub. No.: US 2002/0138470 A1
(43) Pub. Date: Sep. 26, 2002

(54) System and method of personal and business web cards

(75) Inventor: Hongyi Zhou, Beijing (CN)

Correspondence Address: Jie Sha, Suite 3504, 195 North Harbor Drive, Chicago, IL, 60601, US

(73) Assignee: Inter China Network Software Company Limited

(21) Appl. No.: 09/813,748

(22) Filed: Mar. 21, 2001

(51) Int. Cl. G06F 7/00

(52) U.S. Cl. 707/3

(57) ABSTRACT

A system of personal and business web cards comprises at least a server having at least a search engine, at least a database, and a plurality of electronic apparatus being accessible to the Internet and thus connectable with said server through the Internet. The database contains at least personal data and information of individuals who are located within at least one particular geographic area or sign on with an Internet Service Provider (ISP). The database may contain a plurality of sub-databases for a variety of categories of individuals or businesses. Anyone who has an access to the aforesaid server may search any such personal or business information from these databases.

### FIELD OF THE INVENTION

The present invention relates to an online personal information management system, more particularly to a system of personal and business web cards, and a method of managing and accessing the system of personal and business web cards.

### BACKGROUND OF THE INVENTION

Up to now, most all of electronic personal information management (PIM) systems are localized personal information management systems, in which individuals or users of the systems enter the personal data of their own and of their friends or contacts. Such systems are provided in individual electronic apparatus, such as personal computers, palm top computers, or any other kinds of electronic organizers, most using Microsoft Outlook, Lotus, or other address books. However, some of those electronic apparatus may not be easily carried around, some may not be kept handy, and some may not be updated often although certain synchronization software are available. Thus, it indeed causes inconsistence of data stored in various personal electronic apparatus a person may have.

Therefore, several web-based personal information management systems have been established to provide the remote storage and database of personal information, that are accessible through the Internet, such as addresses, calendars, and contacts. Such systems are, for instance, www.ecode.com, www.planetall.com, and www.backup.com. The eCode provides the personal information in electronic card format. Further, there are many existing online telephone directory services in various formats, such as “yellow pages” or “white pages.” With the establishment of remote storage and databases of personal information management, the accompanying technology of accessing such databases has been gradually developed. For instance, the Contact Networks, Inc. has several pending patent applications, e.g., WO 00/67105, WO 00/67106, WO 00/67108, WO 00/67416.

WO 00/67105 discloses a method and apparatus for publishing and synchronizing selected user information over a network. It describes a kind of virtual personal information cards that may be communicated to various receiving users under the control of the publishing user. When the publishing user changes the personal information, such changes will be propagated to all holders of the publishing user's card. However, it dose not teach how the card search is conducted more efficiently, and how such a system can be adopted for various users of different languages.

In almost all of such remote PIM database systems, each entry of such names, telephones, and sometimes addresses can be searched using exact matching words, such as names and telephone numbers, etc. If the entered inquiry cannot exactly match the entry of information, several closest possible entries may be provided for selection. However, quite often the search may end up with a result of “no matching entry.” Thus, the searcher may have to modify the inquiry again and again. Finally, the searcher might give up because of frustration of repeatedly modification of inquiries when no result can be generated through several attempts. This is because most of the time the searcher lacks accurate description of the person being searched, for instance, lacking of correct spelling of the words or exact matching characters to get the correct result, not just some phonetic equivalent words or characters. The problem for such search is the requirement of completely or exact “matching” of the search words with the words of entry or entries. No matching, no result.

In case of searching somebody with whom you do not have any contact for quite a while or someone you just ran into once or twice, you probably do not have much information about him or her. You could hardly remember his or her name. Or sometimes, you lost your collection of business cards or databank or simply you do not have such information handy. Nonetheless, you do know something about him or her, such as where he or she studied, lived or worked before, his or her nickname, or what his or her hobby was, etc. In any event, you do have a desire or necessity to find him or her for whatever reason is, but do not have accurate contact information. Using the aforesaid traditional search method, you will probably get nothing, or will have to try tens or hundreds of times before you finally get the information you want. In the real life, no-body would like to try many times to get a simple search result. Therefore, how we could intelligently find someone's information without too much trouble has become a problem waiting to be solved.

Nowadays, Internet accessible electronic information management apparatus are widely used and becoming more and more popular, such as mobile phones, pagers, notebook computers, palm top computers, or any kinds of personal computers or data apparatus. You may find such an access to such instruments anywhere, such as offices, schools, homes, stores, libraries, or other public facilities. If you are traveling or just away from your own home or office where you usually keep your personal information files or cards, you might think of using the Internet to get what you want. If there were a reliable service on the Internet providing a readily available and accurately accessible database for all of individuals, anyone could then get the contact information of someone wanted from anywhere.

Accordingly, it is an object of the present invention to create a system on the Internet that provides an online service of personal information management, through which any Internet user may obtain a piece of desired information of someone based on a minimum description of that person.

It is another object of the present invention to provide a database system that contains all necessary information of individuals and that can be quickly and accurately searched using any thinkable description of an individual being searched.

It is still another object of the present invention to provide a database system that can be quickly and effectively searched using native languages, such as Chinese or Japanese.

### SUMMARY OF THE INVENTION

According to the present invention, a system of personal and business web cards comprises at least a server having at least a search engine, at least a database, and a plurality of electronic apparatus being accessible to the Internet and thus connectable with said server through the Internet. The database contains at least personal data and information of individuals who are located within at least one particular geographic area or sign on with an Internet Service Provider (ISP). The database may contain a plurality of sub-databases for a variety of categories of individuals or businesses. Anyone who has an access to the aforesaid server may search any such personal or business information from these databases.

The information are arranged in a hierarchical tree and denoted with a Hash table, wherein the server and the corresponding database are constructed such that the search engine perform not only an accurate search but also a fuzzy search, through which an inquiry is first broken down into a plurality of words.

According to the present invention, a method of managing and accessing personal and business contact information at a remote location, through the Internet, comprises the steps of a) providing at least one server having at least one search engine, and a database; b) storing personal and business contact information in said database, including but not limited to names, telephone numbers, addresses and additional background information; c) entering a search inquiry through one of a plurality of Internet accessible users' apparatus; d) analyzing the inquiry with an analyzer with predetermined rules stored therein, and breaking down the inquiry into a predetermined number of words; and e) running said words by the search engine through said database to get a collection of search result, wherein said information are arranged in a hierarchical tree and denoted with a Hash table.

Such electronic apparatus may include individual Internet users' computers, data apparatus, and cellular phones. Thus, the individual Internet users may have an instant access to the aforesaid server to search and exchange any desired information from the database of the aforesaid server. And certainly the individual users may also update their information files through synchronizing with the server.

The variety of electronic apparatus being connected to the aforesaid server may also include intranets with internal databases, other ISPs of their own databases, and even public telephone service providers and cellular telephone service providers of their own databases. Those databases may be equipped with firewalls to protect themselves once they are connected to the aforesaid particular server. Further, the individual users may search from other databases in connection with the aforesaid server through the Internet, while any intranet users may access the aforesaid server through their own intranet or local area network (LAN). The most important is that such connected databases and individuals' equipments may be synchronized with the database of the aforesaid server, which may now be called master server, and with others. Therefore, any update of personal or business information can be simultaneously updated in all equipments. This aspect is described in detail in another patent application of the same assignee that is filed on the same day.

The present invention can be better understood through the following detailed description in connection with the accompanying illustrative figures.

### BRIEF DESCRIPTION OF THE DRAWINGS

FIG. 1A is illustrative of the system of the present invention;

FIG. 1B illustrates a network system of the web card according to the present invention;

FIGS. 2A-C show the appearance of the interactive screen of the present invention;

FIG. 3A shows a conventional arrangement of the data structure for the exact matching search;

FIG. 3B shows an arrangement of the data structure of the present invention;

FIG. 4A is a flow chart of the conventional exact matching search; and

FIG. 4B is a flow chart illustrative of the fuzzy search of the personal and business web cards according to the present invention.

### DETAILED DESCRIPTION OF THE INVENTION

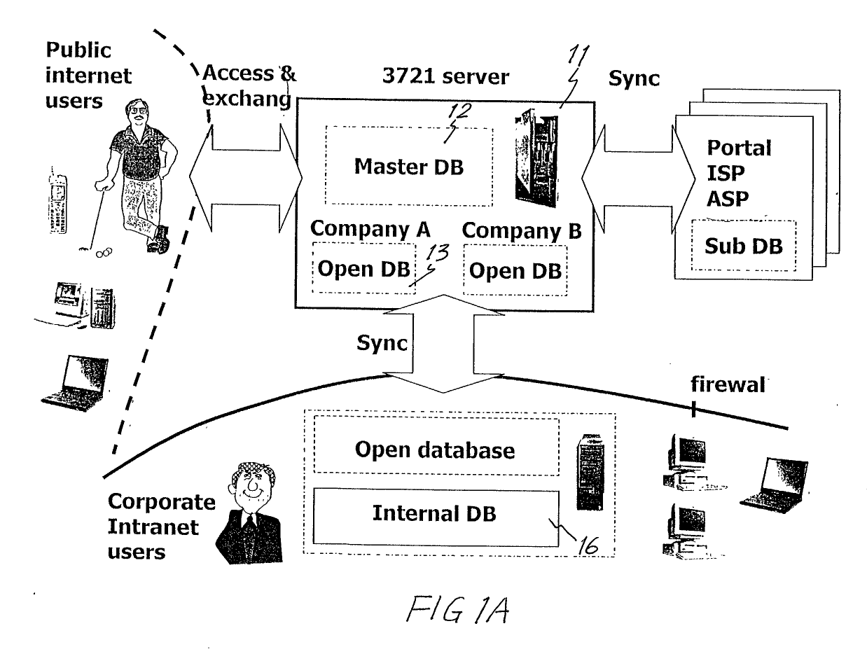

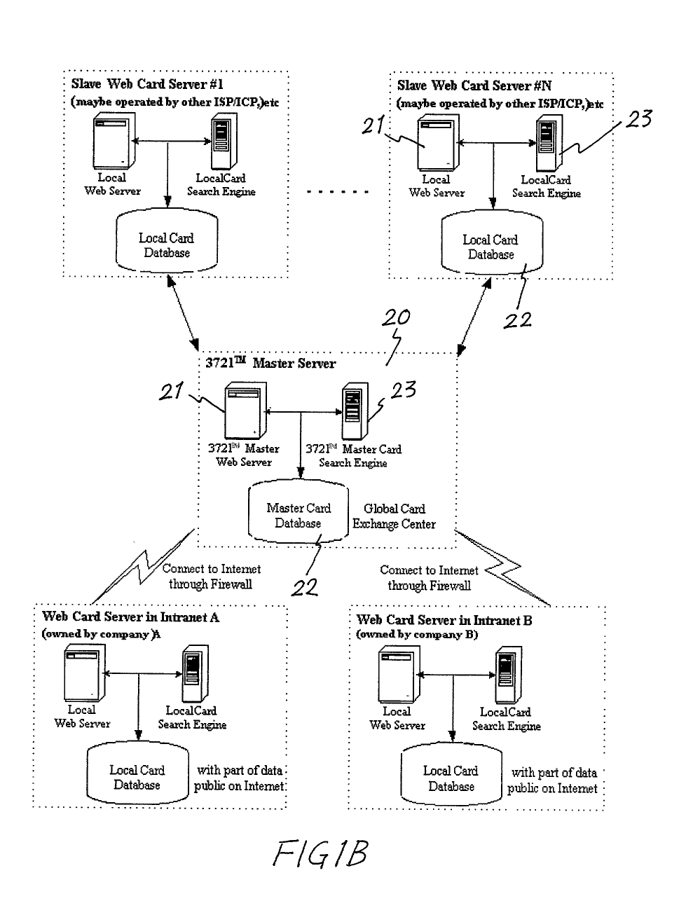

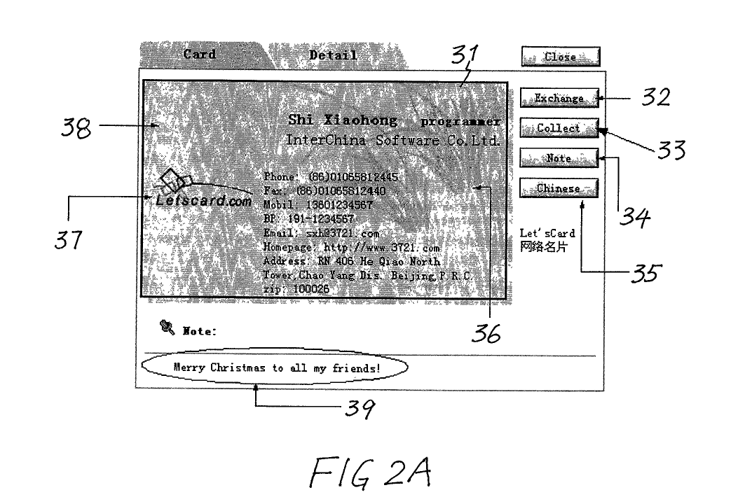

With reference to FIG. 1A, a server 11, as marked 3721™ server, contains a master database 12, and sub-databases 13, such as company A and company B's databases. The various electronic equipments are the public Internet users' tools to access the Internet and then search the 3721™ server 11, such as lap top computers, personal computers, cell phones, and other data apparatus. No matter where they are located, they may conduct a search at the 3721™ server when they log on the Internet. FIG. 1 shows that the public individual users are linked directly to the 3721™ server 11. However, the individual users may also be linked to a portal ISP 14 or ASP 15, and in turn the ISP 14 or ASP 15 is in connection with the 3721™ server 11. The ISP 14 or ASP 15 contains its own database that may include their own personal or business information or telephone directories.

Further, as seen in FIG. 1A, the various electronic equipments may also be an intranet of a company, which contains an internal database of its own. Such an intranet database is normally used for intranet users only. When the intranet users need to search others' information, they may need to access the Internet or outside databases, such as the 3721™ server 11. On the other hand, the personal or business information of others may also be stored therein for use by the intranet users. Such personal or business information of others or publicly known information of the company need to be updated from time to time. In this situation, a firewall is necessary to protect the confidential information in the intranet database.

FIG. 1B illustrates the networking of the personal and business web card system of the present invention. Each block illustrates a web card server or a system unit. Each of such system or unit includes its own card database and card search engine. In consideration of the performance and load balance, each system may comprise one or more physical servers, for instance, one for the master or local web server 16, one for the master or local search engine, and one or more for the master or local database. A service vendor (ISP/ICP, etc) may operate a web card unit independently, while the most important is that these web card units, although independent, can communicate with each other through specific built-in interfaces. Hence, such connected and communicated web card systems or units construct a global distributed web card system. Within such a global system 20, a user may search anyone's web card regardless with which vendor the desired person's web card is registered. Certainly, the users can communicate with each other through their web cards, such as, writing emails, notes, or exchanging web cards.

The global card search may be coordinated by the master card server, such as 3721™ server 11. The master server may coordinate the propagation of data synchronization of any updates between the slave servers. The master server may contain a global card exchange center, and all of the updates or data of the slave servers may be transmitted to the master server for passing on to another or other desired slave services for synchronization of these updates therewith. When a user conducts a search at a slave server, the search will not only performed by the local search engine of the particular slave server, but also be passed onto the master card search engine. These particular features are discussed in the co-pending application of the same assignee.

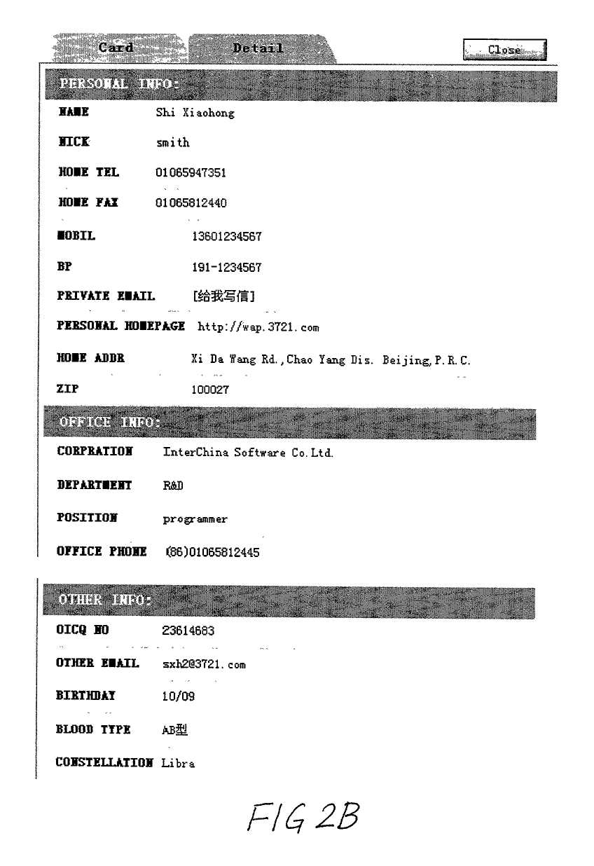

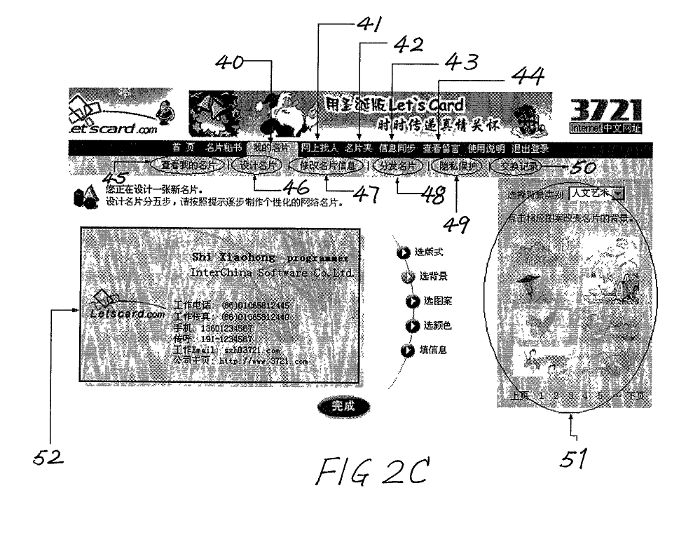

FIG. 2A shows the printout of real web card of the present invention. It can be seen that the personal information stored in the server 11 will appear in a card format 31, in analogy to a business card but much fancier. On the card, one can choose any available decoration 36, such as pet or flowers etc., a logo 37 and any background and color 38. As seen in FIG. 2B, the personal information contains a person's name, telephone number, and correspondence address (either street address or postal box). However, it may contain more information, such as name, address, website of the company where the person works, and telephone and facsimile numbers of the company, the person's cell phone number and email addresses and so on. When a searcher wants to find out a particular person, the search may reveal all of the necessary contact information.

However, none of such information is necessarily to show up on the card if the person chooses not to. Sometimes there is only a name shown up on the card to confirm the search result, while the interactive surface screen provides the searcher with options of communicating with the person being searched, who then may decide whether to contact the searcher. These options may include, but not limited to, personal message box (voice or written), public bulletin board, email box, box for exchanging cards, and even language selection. Assuming that the searcher left message or contact information to the person found through the search, he or she may then call or write back to the searcher if the person found is the right person and would like to communicate with the searcher. In any event, any personal information is sensitive and needs to be protected by all means. This aspect of privacy protection of the present invention is further disclosed in another co-pending patent application of the same assignee.

As shown in FIG. 2C, the features of the web cards of the present invention include my card folder 40, design card 46, search the net 41, and check message 44, etc. In “Design My Card” section 46, there are not just options of card appearances, but also entries of personal information and setting the level of privacy protection. As seen in FIG. 2B, the information about a person's work may include the person's name, company's name and address, the person's job title, telephone number, facsimile number, email, personal web page, mobile phone number, and pager, while the personal information may include the person's gender, age, residential address, home telephone number, etc. The most important feature is that the information entry may also contain more intimate data, such as marriage status, blood type, family physician or attorney, family history, health condition, educational status, location of past residence, date and place of birth, hobby, favorite books, movies, and even photos.

To most of people, they do not intend to disclose the aforesaid information to everybody, but almost always want to disclose such information to different groups of people. For instance, the people may be roughly classified into three groups. The first group includes social or business contacts, the second group is friends and relatives, and the third is family members. However, sometimes, one does not want anyone to know certain “intimate dada” except the ones who must know of the data. Therefore, some or most of the aforesaid “more intimate data” will not be disclosed without specific authorization of the person. Nonetheless, such data may provide a basis for a search. If someone by chance only knows or remembers a few pieces of such information, he or she may still conduct a meaningful search if the person being searched is indeed registered with a local web card system or the global web card system. The search result, however, may not necessarily display the whole lot of information to the searcher, but will at least let the searcher know whether such a person is there, for instance, identified at least by person's name being searched.

FIG. 2C also shows that the interactive screen contains my favorite card folder 42, synchronization 43, modification of web card information 47, distribution of web cards 48, and privacy control 49, card exchange record 50, and selection of background and design area 51. These features are just designed for the users convenience. This will give users more freedom of exercising control of sending and receiving the web cards, such that the personal and business card can be distributed to and synchronized with attempted recipients of the registered user's choice, and the card may be searched by any others with the limitation of the registered user's choice.

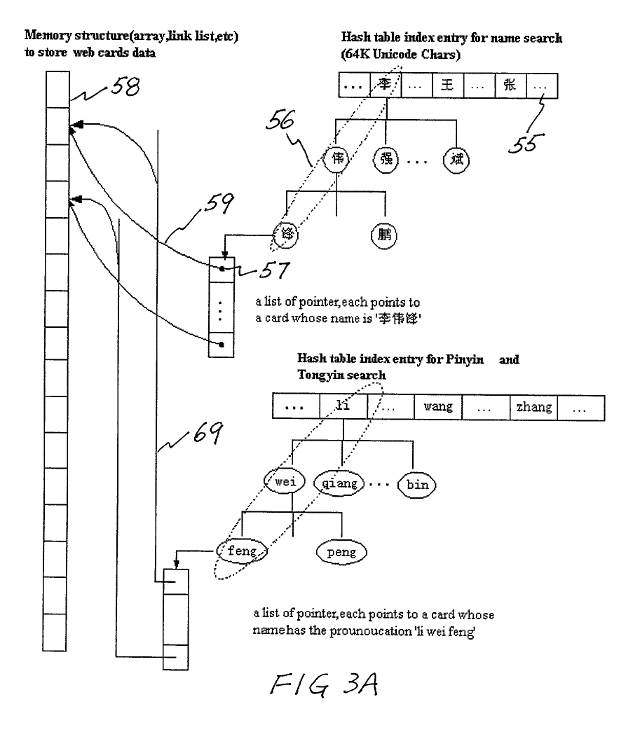

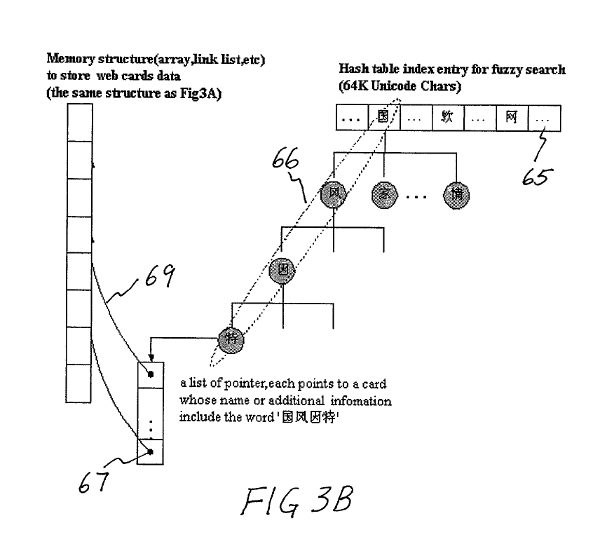

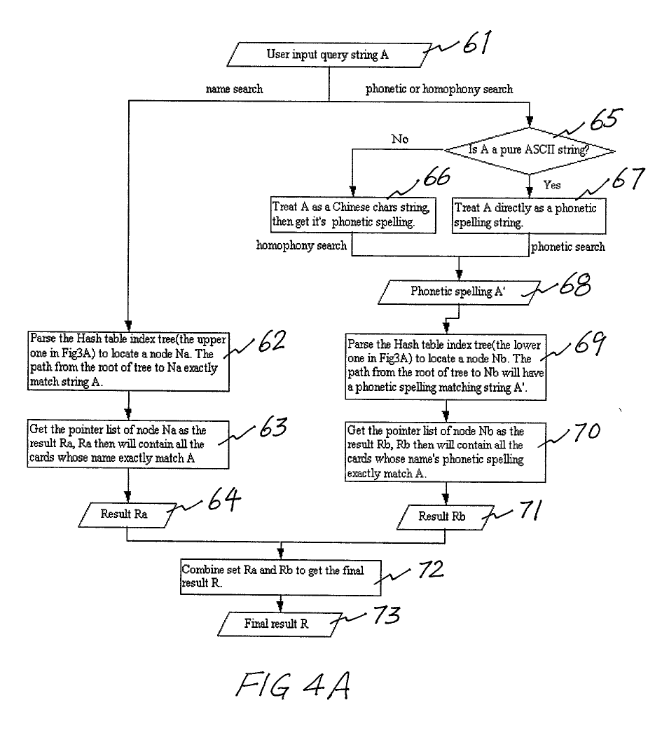

FIG. 3A illustrates the data structure adopted by the card search engine 23 to carry out the conventional search of exact or accurate matching. FIG. 3B illustrates the data structure adopted by the card search engine 23 to carry out a fuzzy or approximate search method in accordance with the present invention. The web card search engine 23 of the present invention performs both of the exact or accurate matching search as well as fuzzy or approximate search. The web card search engine 23 does not use the database of conventional relationship (RDBMS) to carry out the search. To ensure the search speed and efficiency, the specific data structure and indexing structure are established completely in the memory 58.

As seen in FIG. 3A, the key is to set up highly efficient fast indexing in addition to the establishment of the memory structure of the stored web card data therein (e.g., adoption of array and link lists, etc.). The web card search engine 23 utilizes a Hash table 55 and hierarchical structure index 56 to carry out the accurate search of name, and pin-yin (phonetic spelling) and homophony. In the search engine 23, the card data and the index data are all in the form of Unicode. Take the Hash table 55 and hierarchical index tree 56 for accurate or exact matching search as an example. The Hash table 55 is a table containing entries of all 64K characters of the Unicode. Under each entry, there is a branch of the hierarchical tree; each node 57, as shown in dot, contains a pointer 59. Each of such pointers 59 leads to a position of the actual card data stored in the memory. And the names of these cards are the same as the name constructed by all of the characters along the route from the entries of the Hash table to the nodes. Therefore, the accurate search based on names is a process of locating nodes and pointers in the hierarchical tree as illustrated in FIG. 3A. The structure of Hash table plus hierarchical index tree for pinyin or homophony search is similar to that of the search based on characters. The only difference is that the phonetic alphabetic letters, instead of characters, appear at the nodes of the hierarchical tree and the entries of the Hash table.

FIG. 3B illustrates an index structure established for carrying out the fuzzy search at the web card search engine 23. The index structure of FIG. 3B is similar to that of FIG. 3A. However, the characters form Chinese words or a phrase, as they are constructed at nodes 57 from the Hash table 55 to the hierarchical tree 56. Each node 57 contains a card pointer 59. Each pointer 59 leads to the name of the name card or other additional information containing such a word. FIG. 3B is in fact a reversed index based on searching words.

The index structure in FIGS. 3A and 3B are dynamically maintained. That is to say when the user applies for or modifies a web card, the information of this web card will be transmitted to the web card search engine, including the additional searchable information of all characteristics of the card. The search engine 23 will add such information to the two branches of the hierarchical index tree in FIG. 3A in accordance with the name of the card and its Chinese phonetic spelling. At the same time, the additional information and the name of the card will be divided into several words, and these divided words are added into the index pointers 59 corresponding to the nodes 57 of the index tree in FIG. 3B.

At present, almost all of the countries have their specified sets of characters, for instance, the specified set of Chinese characters GB2312. These sets of characters may have correspondence with the set of characters of Unicode. Therefore, the web card search engine uses Unicode characters as the encoding format to store the web card data, such that the search mode of the web card search engine of the present invention may be adopted easily for other languages, such as Japanese and Korean, etc.

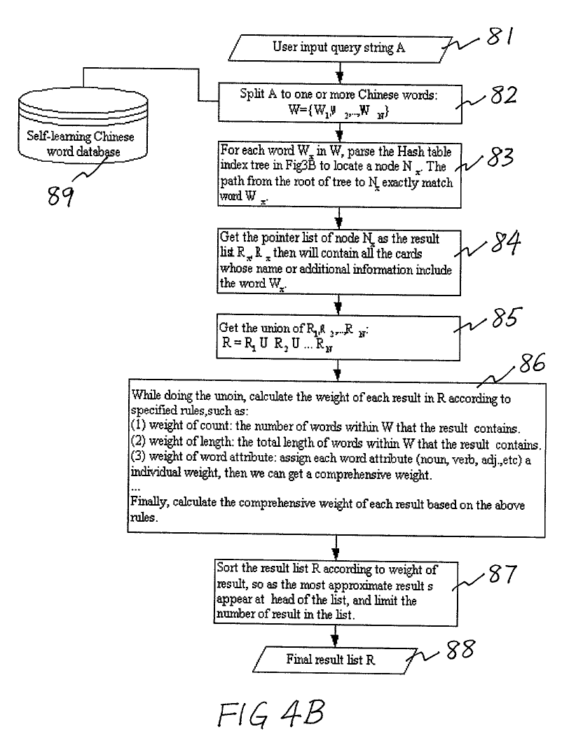

For the detailed description of the web card search of the present invention, FIG. 4A illustrates the flowchart of the search process using the accurate or exact matching search. Under the accurate or exact matching search, the search for a name is carried out by inputting 61 inquiry string A, treating the character stream A of the inquiry as the exact matching words for the name. Based on the first character of the character stream A, it will be easy to locate an entry in the Hash table 55 of FIG. 3A. Then, the following process is to find 62 a node Na within the hierarchical tree connected to this entry, to have the character corresponding to Na being equal to the last character of the character stream A of the inquiry. When the characters from the Hash table entry to the node Na are combined together, they should form the characters stream A of the inquiry. This is a traditional computing method, and its time complexity is O(N), wherein N is the length of the character stream of the inquiry. When the node Na is found, the content directed by the index pointer 63 contained in the node Na will be the desired web cards Ra with all cards matching the inquiry. If such a node is not found, it means that all of the web cards as stored in the memory 58 do not have anything matching the character stream A of the inquiry.

For the same accurate search mode, but based on phonetic spelling or homophony search, it will be substantially the same with such search for characters of the web card as described above. First, it will determine 65 whether the entered inquiry A is a pure stream of ASCII characters. If yes, treat the inquiry A as the pin-ying string 67. Then, the pin-ying string may be divided into several phonetic units in accordance with the Chinese phonetic spelling rules. Such phonetic units constitute a stream of phonetic spelling A′ 68. If the inquiry A contains not only the phonetic spelling alphabetic letters, but also Chinese characters as seen in the step 66, the Chinese characters can be converted into equivalent phonetic units through the conversion table stored in the memory 58. Thus, the stream A′ 68 of phonetic spelling can be obtained easily from the stream A of the initial inquiry. Then, the pertinent nodes Nb may be found 69 for the stream A′ through the index structure as shown in FIG. 3A. Subsequently, the pointer may be found to indicate the result Rb at the step 70 and 71. This process is the same as the process for searching the characters, i.e., the accurate or exact matching search. When combining the results Ra and Rb at the step 72, the final result R may be obtained at the step of 73.

FIG. 4B is the flowchart of the fuzzy or approximate search in accordance with the present invention. As shown in FIG. 3B, the index structure of the fuzzy or approximate search is the same as the structure of the accurate or exact matching search. For an inquiry character stream A inputted at the step 81, such as “I would like to find XYZ who works in Beijing for an IT company” in Chinese “ [symbol] IT [symbol] XYZ” the search engine 23 will break down, at the step 82 the inquiry into several words through a dictionary having self-study ability. Such words constitute a collection W. At the step 83, each word Wx is being dealt with in accordance with the way of computing same as the one for the accurate or exact matching search so as to locate a node Nx among the index structure of FIG. 3B. From each node Nx, a result collection Rx is generated at the step 84. The result collection Rx contains the web cards that have the name or additional information including the word Wx. All of the result collections Rx are consolidated to constitute a big result collection R at the step 85. During the consolidation, the similarity of each card may be evaluated by weight at the step 86. Such similarity may follow certain specific rules. Finally, all of web cards in the big result collection R are sorted out at the step 87 and arranged in accordance with the similarity, and the number of selected search results of web cards is restricted under certain rules so as to obtain the final search result collection R of the fuzzy or approximate search at the step 88.

What is claimed is:

1. A system of personal and business web cards, comprising a server having at least a search engine, at least one database storing personal and business contact information including but not limited to names, telephone numbers, addresses and additional background information, a plurality of public users' apparatus capable of accessing the server and the database through the Internet, wherein said information are arranged in a hierarchical tree and denoted with a Hash table, and wherein the server and the corresponding database are constructed such that the search engine perform not only an accurate search but also a fuzzy search, through which an inquiry is first broken down into a plurality of words.

2. A system of claim 1, wherein said server is connected to the users through any portal of ISP, ASP and LAN.

3. A system of claim 1, wherein the server and database receive a search inquiry from inputting means, and the search engine of the server includes processing means, and control means, and conducts the search first in accordance with the Hash table.

4. A system of claim 1, wherein said accurate search is performed through the Hash table and the hierarchical tree structure, in which nodes along the route from the Hash table to the hierarchical tree constitute the corresponding characters of the inquiry matching the entry of the personal and business contact information.

5. A system of claim 4, wherein the Hash table contains pointers at the nodes directing to the personal and business contact information stored in a memory of the database.

6. A system of claim 1, wherein the fuzzy search is performed by dividing a stream of characters of an inquiry into certain meaningful words in accordance with predetermined rules as stored in a memory of the database.

7. A system of claim 6, wherein each of the divided characters match automatically with web card names, additional information, with respect to the personal and business contact information.

8. A method of managing personal and business contact information at a remote location, that is accessible through the Internet, comprising the steps of:
a) providing at least one server having at least one search engine, and a database;
b) storing personal and business contact information in said database, including but not limited to names, telephone numbers, addresses and additional background information;
c) entering a search inquiry through one of a plurality of Internet accessible users' apparatus;
d) analyzing the inquiry with an analyzer with predetermined rules stored therein, and breaking down the inquiry into a predetermined number of words; and
e) running said words by the search engine through said database to get a collection of search result, wherein said information are arranged in a hierarchical tree and denoted with a Hash table.

9. A method of claim 8, wherein said personal and business contact information is encoded into Unicode, that corresponds to a standard set of characters of a native language.

10. A method of claim 9, wherein the Hash table contains a table of all entries of the Unicode characters, and each entry corresponds to a branch of said hierarchical tree.

11. A method of claim 8, wherein at each of nodes from said Hash table to corresponding branches of said hierarchical tree, a pointer is provided to direct to a piece of the corresponding personal and business contact information.

12. A method of claim 8, further comprising a step of converting characters of said inquiry into corresponding phonetic spelling words in accordance with predetermined rules when the inquiry contains phonetic alphabetic letters before running the search.
